(19) United States
(12) Patent Application Publication
(10) Pub. No.: US 2025/0029168 A1
(43) Pub. Date: Jan. 23, 2025

(54) System and Method for Sponsored Meal Requests and Dispensing

(71) Applicant: Nagesh Kumar Uba, Chandler, AZ (US)

(72) Inventor: Nagesh Kumar Uba, Chandler, AZ (US)

(21) Appl. No.: 18/356,978

(22) Filed: Jul. 21, 2023

Related U.S. Application Data
(60) Provisional application No. 63/514,568, filed on Jul. 19, 2023.

(51) Int. Cl. G06Q 30/0601; G06F 21/62; G06Q 50/12

(52) U.S. Cl. CPC G06Q 30/0635; G06F 21/6254; G06Q 30/0641; G06Q 50/12

(57) ABSTRACT

The present disclosure pertains to a technological implementation encompassing a system and corresponding method enabled via a digital interface (either mobile application or web-based interface). This system facilitates a meal request mechanism for individuals in need and a provision for benefactors to select and finance the requested meals. An associated restaurant having a predefined menu receives payment and order details, thereby facilitating meal dispensing at designated counters using unique identifiers such as order numbers or usernames.

### 1. BACKGROUND OF THE INVENTION

Contemporary solutions to address food insecurity are predominantly dependent on food banks, soup kitchens, and government assistance programs. However, these solutions often lack the ability to provide immediate assistance or personalized meal options, catering to the unique dietary preferences and needs of individuals requiring support. Additionally, benefactors desirous of providing aid often lack a direct and transparent platform that ensures their donations are utilized specifically for meal provision. The present disclosure aims to resolve these challenges by instituting a process and platform that allows individuals in need to place specific meal requests and enables benefactors to directly finance these meals.

### 2. PRIOR ART

Existing systems (Gruber, Harry, et al, 2002) generally focus on providing food aid through philanthropic organizations, governmental programs, or NGOs. These platforms, while providing food assistance, lack (Gruber, Allen, et al, 2002) the facility for personalization and instant provision of meals. Additionally, these systems do not facilitate a direct, transparent channel for benefactors to ensure their contributions are being utilized specifically for meal provision. There exists a gap in systems that enable people in need to request for particular meals and have them sponsored directly.

Existing systems (Hartman, Peri, et al, 1999) also encompass a wide range of online food ordering platforms (WILKINSON, Bruce Walter, et al, 2017). These platforms are primarily designed for convenience (Gibernau, Antonio Montserrate, et al, 1995), allowing users to place orders for meals (Nacey, Gene E, 2011) (Riscalla, Daniel, 2014) (Ekambaram, Vijay, et al, 2019) from various restaurants (Battistini, Michael, 1999) and have them delivered (Maloney, Matthew, 2017) (Conner, Mark H, 2015) or made available for pick up. They've dramatically reshaped the restaurant industry (Auda, Michelle Lynn, et al, 2018), offering digital menus (Belousova, Maria, et al, 2019) (Yin, Huanmi, et al., 2022), user ratings, and a plethora of food choices (Froseth, Barrie R., et al) from multiple cuisines.

However, despite the advanced functionality of these platforms, they primarily cater (Peters, Dan, et al, 2012) to consumers who can afford the luxury of ordering meals online. They lack the feature set to assist individuals who are unable to pay for their meals and nourish (REIDER, Carroll, et al, 2010) (Culver, Stephen F., et al, 2007) (Whalen, Scott Donald, et al., 2010) themselves for daily life. None of these platforms incorporate a sponsorship model where a third party, be it an individual benefactor or an organization, can directly sponsor meals for individuals in need.

While they do offer opportunities for user engagement and promotional campaigns, these are generally aimed at boosting sales, and they do not incorporate a framework to facilitate social welfare or philanthropy. The lack of integration between these online food ordering systems and initiatives to sponsor meals for those in need further exacerbates the gap in current systems, creating a need for a solution that combines the convenience and extensive reach of online food ordering with the direct, transparent provision of sponsored meals.

### 3. SUMMARY OF THE INVENTION

This disclosure embodies a system and method that enables individuals in need (“requesters”) to place specific meal requests from a predefined menu offered by participating restaurants. These meal requests are displayed on a digital interface accessible by benefactors (“sponsors”), who can select and finance these meals. Upon successful payment, the meals are prepared by the restaurant and can be collected by the requesters at designated counters utilizing unique identifiers such as order numbers or usernames. Restaurants offering food services can participate in this program by registering on a merchant portal.

### 4. ADVANTAGES OF THE INVENTION

1. The proposed system delivers an immediate, personalized solution enabling individuals in need to receive meals.
2. The system furnishes a direct, transparent mechanism for benefactors to provide meals, instilling trust, and visibility in the process.
3. It offers a platform for restaurants to participate in social service initiatives, potentially increasing their patronage.
4. The utilization of unique identifiers, such as order numbers or usernames, maintains the privacy and dignity of the requesters.

### 5. BRIEF DESCRIPTION OF THE DRAWINGS

FIG. 1 is a block diagram illustrating the system architecture of an exemplary embodiment of the present invention, delineating various components of the system, and illustrating their interconnections.

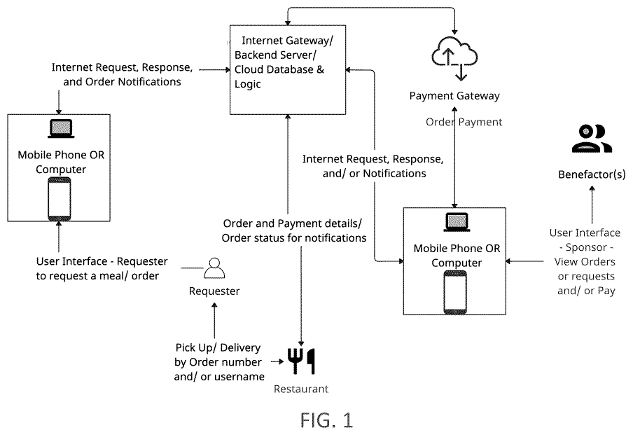

FIG. 2 is a diagrammatic representation showing exemplary user interface screens of the present invention, in accordance with an illustrative embodiment. This figure highlights salient features, input mechanisms, and output displays with which a user may interact during operation of the system.

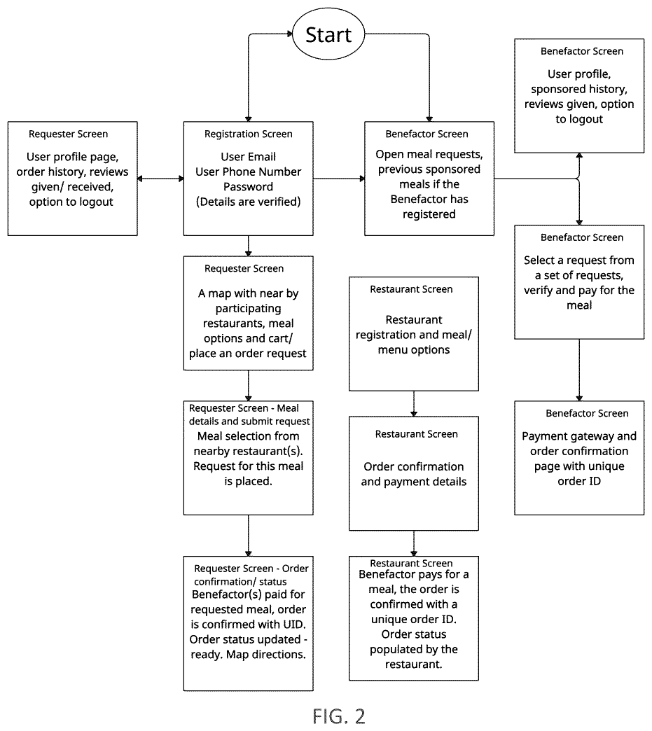

FIG. 3 is a flowchart outlining a process flow executed by the system in accordance with an exemplary embodiment of the present invention. It provides a detailed sequence of steps or operations performed by user(s), merchant(s) and the system, and graphically illustrates the system's response to various input conditions and scenarios.

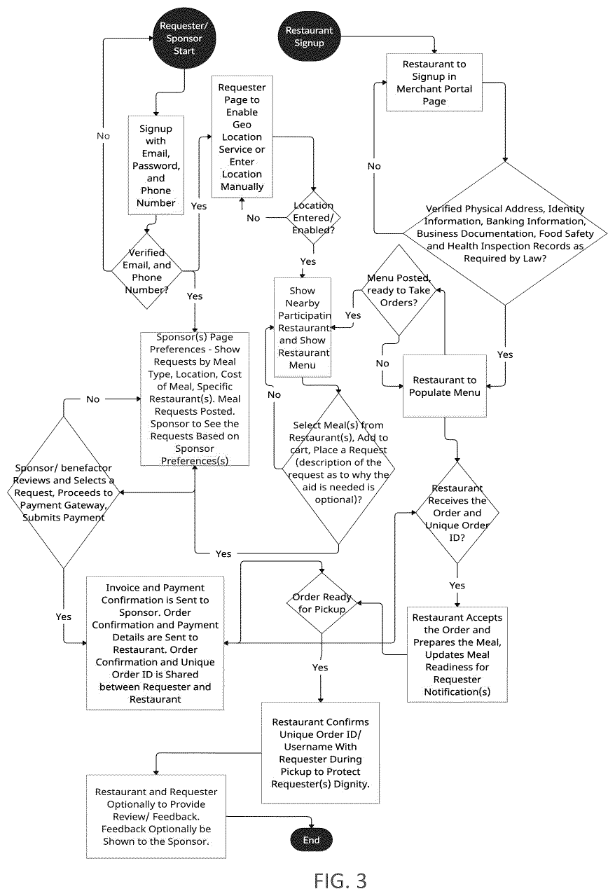

The drawings contained herein are schematic and not drawn to scale. The relative dimensions and proportions of parts depicted in the drawings may have been modified and/or exaggerated for purposes of clarity and illustration.

It will be appreciated by those of ordinary skill in the pertinent art that the drawings are illustrative in nature and are not intended to unduly limit the scope of the accompanying claims. These drawings should be interpreted in conjunction with the detailed description contained in the specification, wherein the detailed description provides further specifics and elaborates on the depiction presented by the drawings.

### 6. DETAILED DESCRIPTION

The system necessitates requesters to register on the platform via a digital interface, providing requisite details such as name, contact information, and location.

Requesters can access the meal menu offered by nearby participating restaurants and place a meal request.

Meal requests, without divulging personal details of the requesters, are displayed on the platform, accessible to benefactors.

Benefactors can review these requests and select specific ones to sponsor. They can facilitate payment for these meals directly on the platform.

Upon successful payment, order details and payment are relayed to the respective restaurant, which prepares the meal.

The requester is notified when their meal is prepared and ready for collection, utilizing a unique identifier such as an order number or username for identification.

The platform retains a log of all transactions, ensuring transparency and accountability.

Restaurants that want to participate in this program registers in a merchant portal with a predefined menu.

### System Architecture

1. User Interface (UI): The UI would have separate sections for Requesters and Benefactors. Each section would have its own set of pages including login, registration, dashboard, restaurant details, cart, meal request page, payment gateway, order confirmation, notification center, user profile, and rating & review page.
2. Back-end Server: The back-end server would be responsible for processing the requests from the UI and performing the appropriate actions. It would communicate with the database to store or fetch information, handle business logic, and generate responses to send back to the UI.
3. Database: The database would store all necessary information, including user details (both for requesters and benefactors), restaurant details, meal options, meal requests, sponsored meals, notifications, and reviews.
4. Restaurant Interface: The restaurant interface would have features allowing restaurants to manage their details, meal options, view and manage orders, and reviews.
5. Payment Gateway: A secure payment gateway would handle all transactions. It would interface with the benefactor's bank or credit card provider to authorize and complete payments. It would also provide receipts for successful transactions.
6. Notification System: This would be responsible for sending alerts to users. It could send push notifications to the UI, or it could send emails or SMS messages to the users, depending on their preferences.
7. Geolocation Service: This service would handle tasks related to location. It would be used to show nearby restaurants to requesters, based on their current location. Directions to the nearby restaurant is also shown when the order is accepted and ready by the restaurant.
8. Rating and Review System: This system would manage the ratings and reviews given by requesters and received by restaurants. It would update the overall rating of restaurants based on new reviews.
9. Security Layer: An important part of the architecture, the security layer would ensure all data is encrypted and secure. It would also protect against unauthorized access and attacks.
10. APIs: The system would use various APIs to communicate between different components of the architecture. For example, APIs would be used to interact with the payment gateway, geolocation service, and the UI.
11. Admin Panel: An admin panel for system administrators to monitor system health, user activities, handle customer complaints, and perform other administrative tasks.

### User Interface

1. Login/Registration Page: This page would contain fields for username, password, and options for sign-up if the user is new. It has options for password recovery and contact information for support.
2. Home Screen: This screen is the main dashboard after a user logs in. For a requester, it would show nearby restaurants, meal options, and their cart. For a benefactor, it would display available meal requests and their previous sponsored meals.
3. Restaurant Details Page: Upon clicking a restaurant marker on the map, or from a list, a requester would see this page. It would have the restaurant's name, hours, meal options, and estimated preparation times. The page would also have an ‘Add to Cart’ button next to each meal.
4. Cart Page: This page would display all the meals that the requester has selected, the total cost, and an option to ‘Place Request’. Once a request is placed, it would be visible to the benefactors.
5. Meal Request Page: Benefactors would see this page after clicking on a meal request. It would display the meal details, cost, restaurant, and an option to ‘Sponsor this Meal’. It would also contain the restaurant's rating, user reviews, and estimated time of meal preparation.
6. Payment Gateway Page: This secure page would allow benefactors to pay for the meals they have chosen to sponsor. The page would provide an invoice detailing the cost and an option to confirm the payment.
7. Order Confirmation Page: After a meal is sponsored, the benefactor would be directed to this page. It would contain the details of the meal, confirmation of payment, and the unique order ID.
8. Notification Center: Both requesters and benefactors would have a notification center showing updates about meal requests, preparation statuses, and ready for pickup notifications.
9. User Profile Page: Each user (requester/benefactor) would have a profile page containing their personal information, order history, reviews given or received, and an option to log out.
10. Rating & Review Page: After a meal has been picked up, both the requester and the restaurant can rate and review each other. This page would contain star-rating options and a text box for the review.

### Process Flow

1. User Verification and Registration: Requester and benefactor need to verify their identity using valid identification before registration. This ensures the legitimacy of users on the platform and discourages fraudulent activities.
2. Requester Registration: The requester creates an account providing details like their name, contact information, email, and a password. The platform uses encryption to ensure the security of sensitive information.
3. Geolocation Services: The platform uses geolocation services to identify the location of the requester. This can be done automatically with the user's permission, or they can manually input their location.
4. Viewing Nearby Restaurants: The platform displays a map showing nearby participating restaurants. The map may include clickable markers for each restaurant. Clicking on a marker displays details such as the restaurant's name, hours, available meals, and estimated meal preparation times.
5. Meal Selection & Request: The requester can select meals from different restaurants, add them to their cart, and place the request on the platform. The platform generates a unique order ID for each request.
6. Benefactor Registration: Similar to the requester, the benefactor signs up providing their personal details and verifying their identity.
7. Setting Benefactor Preferences: Benefactors can set preferences for the types of requests they want to see. Preferences can include location, meal type, cost of meals, and specific restaurants.
8. Viewing Meal Requests: The benefactor views a dynamic, real-time updated list or map of meal requests. Filters allow benefactors to view requests that match their preferences. Each request includes details about the meal, the restaurant, the estimated meal preparation time, and the cost of the meal.
9. Sponsoring a Meal: The benefactor selects a request that they want to sponsor and proceeds to secure online payment gateway. The platform provides a detailed invoice and sends a confirmation email once payment is successful.
10. Restaurant Receives Order: The participating restaurant receives the order details and the payment confirmation via a secure restaurant dashboard on the platform. The restaurant also gets a unique order ID that matches the one provided to the requester.
11. Meal Preparation & Setting Designated Counter: The restaurant prepares the meal and assigns it to a designated counter for pickup. The counter is monitored by restaurant staff to ensure the meals are picked up by the correct person.
12. System Notification: The restaurant confirms the meal readiness through their dashboard. The platform then generates a notification and sends it to the requester through email and/or app notification.
13. Meal Pickup: The requester receives the notification that their meal is ready. They go to the restaurant, show their unique order number at the designated counter to collect their meal.
14. Rating and Review: After the meal is picked up, both the requester and the restaurant have the option to rate and review the other party. This helps in maintaining the quality of the service provided by the platform.

1. A system for sponsored meal requests and dispensing, comprising: a digital interface accessible by requesters and benefactors; a meal request module enabling requesters to select meals from a predefined menu; a payment module facilitating benefactors to finance selected meals; a notification system alerting requesters when meals are paid, prepared and ready for collection.

2. The system of claim 1, wherein the meal requests are displayed on the digital interface without divulging personal details of the requester, ensuring privacy and safety.

3. The system of claim 1, further incorporating a logging system that maintains records of all transactions, providing transparency and accountability.

4. The system of claim 2, further characterized by a privacy module, wherein the meal requests are anonymized using a unique order number or username, further fortifying the safeguarding of personal data, and preserving the dignity of the requester.

5. The system of claim 3, wherein the transaction logging system is equipped with features to generate statistical reports, providing a detailed breakdown of sponsored meals by location, frequency, and benefactor activity, thereby facilitating analysis and evaluation of the system's impact.

6. A method for sponsored meal requests and dispensing, comprising the steps of:
registering on the platform; placing a meal request; displaying the meal request on the platform; a benefactor selecting and financing the meal; relaying order details and payment to the corresponding restaurant; notifying the requester when the meal is prepared for collection.

7. A system for sponsored meal requests and dispensing, comprising:
Digital Interface: A web-based or mobile interface coded in React Native programming language, configured to display meal options and facilitate user interactions without divulging any private information.
Meal Request Module: A backend server running as cloud service such as AWS or Google Cloud, integrated with a database, enabling requesters to select meals from a predefined menu stored in the database. The module executes a selection algorithm based on user preferences and location data.
Payment Module: A secure payment gateway, such as Stripe API, configured to process electronic transactions, and handle financial data securely.
Notification System: A communication module using cloud messaging services such as Firebase Cloud Messaging or AWS, configured to send real-time notifications via SMS, email, or in-app alerts when meals are paid, prepared, and ready for collection.

8. The system of claim 1, further incorporating a logging system implemented on platforms such as Google Cloud logging or AWS, configured to maintain records of all financial and transaction data, with capabilities to generate real-time reports and audits that can be requested by sponsors for accountability.

9. The system of claim 2, further characterized by a privacy module, implemented using Epileptic Curve or RSA private and public key encryption methods, wherein meal requests are anonymized by encrypting user details and assigning a unique, randomized identifier for each transaction.
